(19) United States
(12) Patent Application Publication
(10) Pub. No.: US 2018/0056731 A1
(43) Pub. Date: Mar. 1, 2018

(54) RUN FLAT TIRE AND METHOD OF MAKING SAME

(71) Applicant: Tire Spine, LLC, Mountain City, GA (US)

(72) Inventors: Terry Lee, Clayton, GA (US); Eric Radford, Clayton, GA (US); Dwight Pollard, Clayton, GA (US)

(21) Appl. No.: 15/689,441

(22) Filed: Aug. 29, 2017

Related U.S. Application Data
(60) Provisional application No. 62/380,884, filed on Aug. 29, 2016.

(51) Int. Cl. B60C 17/06; B60B 23/10; B60C 13/00

(52) U.S. Cl. CPC B60C 17/06; B60C 17/0009; B60C 13/00; B60B 23/10

(57) ABSTRACT

A run-flat tire insert, according to particular embodiments, that is configured to be received inside a cavity of a tire. The run-flat tire insert comprising a monolithic, generally toroid shaped insert that includes (a) a first and a second sidewall, (ii) an outer surface that couples the first sidewall to the second sidewall, and (iii) an inner surface that couples the first sidewall to the second sidewall. Additionally, the monolithic, generally toroid shaped insert has an outer diameter that is substantially equal to an outer diameter of a tire in which the monolithic, generally toroid shaped insert will be installed into when the tire is not inflated with air.

### CROSS-REFERENCE TO RELATED APPLICATIONS

This application claims priority to U.S. Provisional Patent Application Ser. No. 62/380,884, filed Aug. 29, 2016, the disclosure of which is hereby incorporated by reference in its entirety.

### BACKGROUND

Oftentimes objects present on roadways and other paths taken by a vehicle are capable of puncturing the tires of the vehicle. When a tire is punctured by such objects, the tire may lose the ability, in some cases suddenly and in other cases over an extended period of time, to maintain sufficient air pressure for operation of the tire. In either case, however, such air loss may result in a “flat tire.” In military applications, flat tires can be both a life or death situation and/or the cause of a mission failure. In the race world, a flat tire may result in a competitor spending extra time changing the tire or ending the race altogether if no spare is available. One of the challenges in designing tire inserts that maintain operability of the tire (i.e., that create a run-flat tire) is to make an insert that does not deteriorate with use of the tire and enables the tire to be filled sufficiently with the insert. Conventional approaches to tire insert construction call for using heavy-duty materials or liquid foam that is injected into the tire using foaming agents that cures to a solid. Although such inserts and foams may not deteriorate, these materials do not compress enough so that a tire could be substantially filled. In other conventional approaches, inserts made from Styrofoam-like material were used within tires. However, such inserts are subject to rapid deterioration.

As previously described, an out of balance tire condition may result from both of these approaches, making continued operation of the tire unfeasible. Moreover, many conventional approaches are often designed as a temporary solution that enables a vehicle with a compromised tire to travel to a location where the tire can be fixed and where air pressure can be restored—provided the tire makes it to that point before it de-beads or is otherwise destroyed. The present systems and methods of providing a run-flat tire address the deficiencies found in the prior art.

### SUMMARY

A run-flat tire, according to particular embodiments, comprising: (a) a monolithic, generally toroid shaped insert comprising (i) a first and second sidewall, (ii) an outer surface that couples the first sidewall to the second sidewall, and (iii) an inner surface that couples the first sidewall to the second sidewall; (b) a tire comprising (i) a first tire sidewall having a first edge defining a first bead and a second edge, (ii) a second tire sidewall having a first edge defining a second bead and a second edge, and (iii) a tread coupling the first tire sidewall second edge to the second tire sidewall second edge; and (c) a rim, wherein the monolithic, generally toroid shaped insert has an outer diameter that is substantially equal to the outer diameter of the tire when the tire is not inflated with air, and the monolithic, generally toroid shaped insert has an inner diameter that is slightly smaller than the outer diameter of the rim so that when the rim is inserted into an opening defined by the inner surface, the monolithic, generally toroid shaped insert has a friction fit with the rim.

A run-flat tire insert that is configured to be received inside a cavity of a tire, according to particular embodiments, comprising a monolithic, generally toroid shaped insert comprising (i) a first and second sidewall, (ii) an outer surface that couples the first sidewall to the second sidewall, and (iii) an inner surface that couples the first sidewall to the second sidewall, and wherein the monolithic, generally toroid shaped insert has an outer diameter that is substantially equal to an outer diameter of a tire in which the monolithic, generally toroid shaped insert will be installed into when the tire is not inflated with air.

A method of installing a run-flat tire insert into a tire, according to particular embodiments, comprising: (a) compressing a first portion of a monolithic, generally toroid shaped insert; (b) pushing the first portion into a cavity defined by a tire inner surface, a first tire sidewall, and a second tire sidewall; (c) continually compressing a second portion of the monolithic, generally toroid shaped insert; (d) pushing the second portion into the cavity of the tire; (e) compressing a last portion of the monolithic, generally toroid shaped insert; and (f) pushing the last portion into the cavity of the tire, wherein the monolithic, generally toroid shaped insert expands when placed into the cavity of the tire so that at least a portion of an outer surface of the monolithic, generally toroid shaped insert is positioned against at least a portion of the tire inner surface, and at least a portion of a sidewall of the monolithic, generally toroid shaped insert is positioned against a portion of at least one of the first tire sidewall and the second tire sidewall when the tire is not inflated.

These and other features, aspects and advantages of the present disclosure will become better understood with reference to the following description and appended claims. The accompanying drawings, which are incorporated in and constitute a part of this specification, illustrate embodiments of the present disclosure and, together with the description, serve to explain the principles of the present disclosure.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an apparatus in an example implementation in which a monolithic, generally toroid shaped insert is shown by a cut away portion as positioned within a tire.

FIG. 2 is a three-dimensional illustration of a monolithic, generally toroid shaped insert.

FIG. 3 is a flow diagram depicting a method in an example implementation that is used to substantially fill an inside of a tire with a monolithic, single layer of generally toroid shaped continuous unit of foam to operate the tire with or without air pressure.

FIG. 4 is a generic illustration of one example of installation of which a monolithic, generally toroid shaped insert is positioned within a tire.

FIGS. 5A-5G show another embodiment of a sequence of steps in an example implementation to cause the monolithic, generally toroid shaped insert to be positioned within a tire.

### DETAILED DESCRIPTION

### Overview

A run-flat tire, in accordance with various embodiments, comprises a monolithic, generally toroid shaped insert that is inserted into a standard tire to allow the tire to continue operating when the tire has been compromised (e.g., when the tire loses air pressure). In one or more embodiments, the monolithic, generally toroid shaped insert 105, 200 is formed from industrially cut closed cell, crosslinked foam. In various embodiments, the monolithic, generally toroid shaped insert 105, 200 may be molded using a proper mold via any suitable molding process (e.g., an endothermic process, injection molding process, etc.). For purposes of this disclosure, a toroid is a surface of revolution with a hole in the middle. In the present invention, the surface of revolution may be any shape of a tire, and the generally toroid shaped insert is configured to fit in the interior portion of the tire. When the surface of revolution is created for the revolved figure of a circle, the created toroid is a torus. However, it should be understood that the surface of revolution may be created for any polygonal shape such as a square, a trapezoid, a triangle, etc. to form a toroid of varying outside dimensions.

The monolithic, generally toroid shaped insert may be shaped such that when inserted into a tire, the inside of the tire is uniformly filled, when the tire is not under pressure. Silicone may be applied to the monolithic, generally toroid shaped insert and/or the inner carcass of the tire to lessen the results of friction on the foam when the insert is being placed into the tire. Once the insert is placed into the tire, the tire can be inflated to the desired air pressure for normal operation. Because of the density of the foam and the design of the monolithic insert, a failed tire can still be used for normal or near normal operation for a period of time.

Another benefit of a monolithic foam structure is that it is not dependent on air in any way unlike some of the conventional run-flat tire techniques. Consequently, a monolithic foam structure may be used at high speeds and in high-stress environments, such as military applications or for racing vehicles. In potential high-stress situations and environments during military use, being able to continue moving at full operating capability and speed will not only help ensure personal safety, but potentially aid with mission and activity success. Furthermore, in high-stress environments like long distance racing, being able to continue using a compromised tire may make a significant difference in race results as there may be no need to actually change a failed tire.

In the following discussion, a foam insert is described, by way of example, as being used in a tire that may be installed on a vehicle, such as being operably attached (e.g., press fitted to, in abutment with) within the tire to a rim of the vehicle or positioned adjacent to the surface of the rim. However, it should be readily apparent that the following discussion is not limited to a particular vehicle, a particular tire that corresponds to the particular vehicle, or attaching such a tire to a rim of the vehicle. Accordingly, these techniques may have a variety of applications, such as for automobiles, motorcycles (e.g., road or motocross), ATVs, UTVs, rock crawlers, sand rails, military vehicles, industrial vehicles, human-powered vehicles (e.g., bicycles), airplanes, etc.

### Example Apparatus

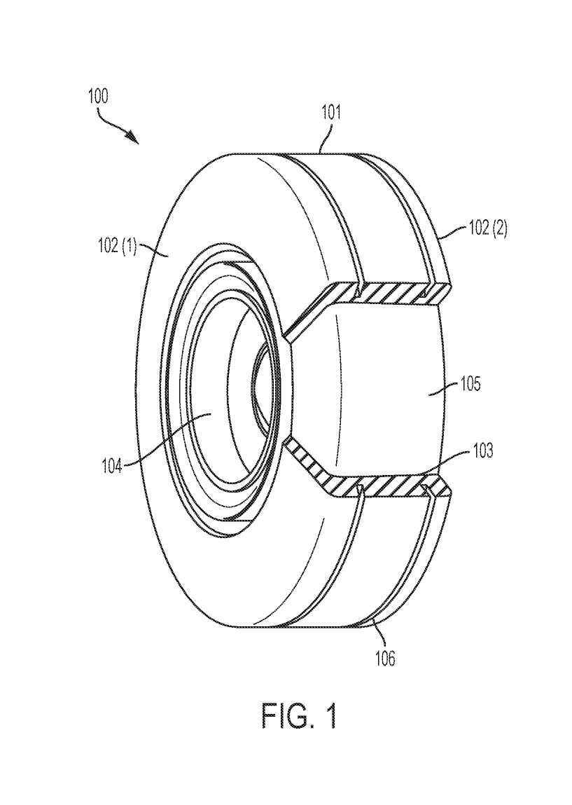

Referring to FIG. 1, an illustration of a run-flat tire 100 is shown. The run-flat tire 100 comprises a tire 101 with a first sidewall 102(1), a second sidewall 102(2), an inner surface 103 that extends between the first 102(1) and second 102(2) sidewalls of the tire 101, and a tread 106, which is an exterior surface of the tire 101, that extends between the exterior of the first 102(1) and second 102(2) sidewalls of the tire 101 (e.g., which may define the outer diameter of the tire). The run-flat tire 100 also comprises a monolithic, generally toroid shaped insert 105 that substantially fills a cavity 104 of the tire 101 where the cavity 104 is defined, at least in part, by sidewalls 102(1), 102(2) of the tire 101 and an inner surface 103 of the tire 101. The tire also includes an opening 107 that is for receiving a rim component, as will be discussed further below.

The monolithic, generally toroid shaped insert 105 has a shape and rigidity such that when inserted into the tire 101, the monolithic, generally toroid shaped insert 105 substantially fills the interior portion of the tire 101. For example, the monolithic, generally toroid shaped insert 105 may fill the cavity 104 inside the tire 101. In particular embodiments, the monolithic, generally toroid shaped insert 105 may be made from lightweight industrial foam, such as closed cell crosslinked polyethylene bun foam. The closed cell crosslinked polyethylene bun foam also provides a rigidity that enables the tire 101 filled with such foam to maintain operability at high rates of speed and over extended distances. Additionally, the material from which the monolithic, generally toroid shaped insert 105 is made may be capable of absorbing shock and protecting against vibration. Further, the material of the monolithic, generally toroid shaped insert 105 may also protect from electric static thereby preventing other damage that may arise from a compromised tire. In various embodiments, the monolithic, generally toroid shaped insert 105 may be formed from a closed or open cell crosslinked polyethylene, polyurethane, or polypropylene foam material with or without an ethylene vinyl acetate copolymer.

In the illustrated embodiment of FIG. 1, sidewalls 102(1) and 102(2) and tread 106 are shown as distinct surfaces. It should be noted however, that in some implementations tire 101 may have a curved shape surface such that the sidewalls 102(1), 102(2) blend into the tread 106 of the tire 101. In other words, the sidewalls 102(1), 102(2) may not appear to be distinct surfaces from the tread 106 the tire 101. It should be readily apparent that tire 101 may have a variety of different shapes. Consequently, the monolithic, generally toroid shaped insert 105 may be shaped to uniformly substantially fill the inside of a variety of differently shaped tires. For example, the monolithic, generally toroid shaped insert 105 used to fill the tire of an ATV may be shaped differently than the monolithic, generally toroid shaped insert 105 used to fill the tire of a road bicycle, or the monolithic, generally toroid shaped insert 105 used to fill the tire of an airplane.

In one or more embodiments, the monolithic, generally toroid shaped insert 105 is toroidal in shape. For example, the monolithic, generally toroid shaped insert 105 may be shaped such that the sides of the monolithic insert 105 are positioned at least partially against the inner surface of sidewalls 102(1), 102(2) of the tire 101. In various embodiments, the outer circumference of the monolithic, generally toroid shaped insert 105 is positioned at least partially against the inner surface 103 of the tire 101, and in other embodiments, outer circumference of the monolithic, generally toroid shaped insert 105 may be positioned slightly radially inward of the inner surface 103 of the tire 101.

Still referring to FIG. 1, once the tire 101 is installed on a vehicle, portions of the monolithic, generally toroid shaped insert 105 that extend into the cavity 104 of the tire 101 may be positioned against a standard beaded rim, beadlock, two-piece multiple piece rim, or any other suitable rim on which the tire is mounted. In this way, the monolithic, generally toroid shaped insert 105 may be positioned at least partially against the rim on which the tire 101 is mounted, the sidewalls 102(1), 102(2), and an inner surface 103 of the tire 101 that is adjacent to the tread 106 may be partially positioned against (against, partially against, etc.) the monolithic, generally toroid shaped insert 105.

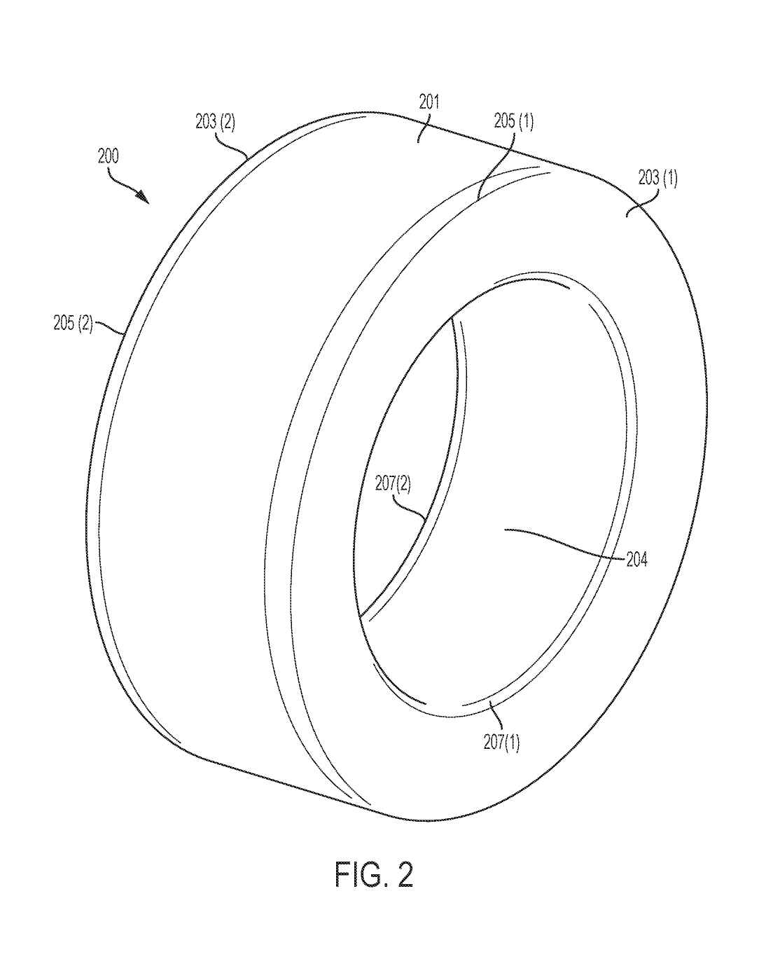

Referring to FIG. 2, a monolithic, generally toroid shaped insert 200 is shown for use as the monolithic, generally toroid shaped insert 105 shown in FIG. 1. In various embodiments, the monolithic, generally toroid shaped insert 200 comprises a first sidewall 203(1) and a second side wall 203(2) that are spaced apart from one another and are coupled by a generally horizontal outer surface 201. The monolithic, generally toroid shaped insert 200 also comprises an inner surface 204. In various embodiments, the inner surface 204 may be narrower than the outer surface 201 so that the side walls 203(1) and 203(2) slant inward. In other embodiments, the inner surface 204 may be substantially the same size as the outer surface 201 so that the sidewalls 203(1) and 203(2) are substantially parallel to one another. In still other embodiments, the outer surface 201 may be wider, narrower, or substantially equal in width relative to the inner surface 204, and the side walls 203(1) and 203(2) may be substantially planar, convex shaped, or concave shaped in the radial direction depending on the application for the monolithic, generally toroid shaped insert 200.

Furthermore, in particular embodiments, the outer edges 205(1) and 205(2) where the sidewalls 203(1) and 203(2), respectively, meet the outer surface 201, and the inner edges 207(1) and 207(2) where sidewalls 203(1) and 203(2), respectively, meet the inner surface 204 are rounded. In other embodiments, the inner edges 207(1), 207(2) and outer edges 205(1), 205(2) may be squared or shaped in any manner based on the application of the insert (e.g., based on the shape of the tire that the insert 200 is being inserted into and the use of the tire), and they may be similar or different angles and shapes from one another.

The monolithic, generally toroid shaped insert 200, may be made from a material having a rigidity that sufficiently enables the monolithic, generally toroid shaped insert 200 to be positioned within the tire 101 (FIG. 1) so that the insert uniformly fills the tire when deflated. Further, the rigidity of the material should be sufficient to maintain operability of the tire in high-stress environments without positive air pressure. In various embodiments, the monolithic, generally toroid shaped insert 200 may be made from lightweight industrial foam, such as closed cell, crosslinked polyethylene bun foam. The closed cell crosslinked polyethylene bun foam has a rigidity that enables a tire 101 filled with such foam to maintain operability. Additionally, the closed cell, crosslinked polyethylene bun foam may be capable of absorbing shock and protecting against vibration thereby preventing an out of balance condition, which can cause potentially damaging vibrations that cause the closed cell, crosslinked foam to breakdown.

To determine proper material to use for the insert, the weight of the vehicle is only one of the many factors that affect the density configuration of the foam material. Other factors include the weight of the occupants in the vehicle, conditions in which the vehicle will be driven in, and the environment the vehicle will operate in. For example, in military applications, vehicles carry more weight but travel at a much slower rate of speed, thereby calling for a denser foam insert. In comparison, in a racing environment where vehicles can weigh less, but travel at much higher rates of speed, a less dense foam material can be used when making the monolithic, generally toroid shaped insert 105, 200. A lower density material allows the monolithic, generally toroid shaped insert 105, 200 to absorb impact unlike a higher density material would, thus resulting in a more comfortable overall ride.

In some embodiments, the following is a general guide for determining the proper density for a particular application. A four-wheeled vehicle weighing from 100-600 pounds would require a foam density ranging from 1.5 lbs/ft³-4 lbs/ft³. A four-wheeled vehicle weighing from 600-1,300 pounds would require a foam density ranging from 2 lbs/ft³-6 lbs/ft³. A four-wheeled vehicle weighing from 1,300-5,000 pounds would require a foam density ranging from 3 lbs/ft³-12 lbs/ft³. A four-wheeled vehicle weighing from 5,000-12,000 pounds would require a foam density ranging from 4 lbs/ft³-12 lbs/ft³. Finally, a four-wheeled vehicle weighing 12,000-20,000 pounds would require a foam density ranging from 6 lbs/ft³-15 lbs/ft³. With regard to two-wheeled vehicles, a two-wheeled vehicle weighing from 5-100 pounds would require a foam density ranging from 1.5 lbs/ft³-4 lbs/ft³. A two-wheeled vehicle weighing from 100-1,000 pounds would require a foam density ranging from 2 lb/ft³-6 lb/ft³.

In various embodiments, the monolithic, generally toroid shaped insert 105, 200 may be lubricated to increase the durability of the insert 105, 200. For example, Dimethylpolysiloxane Silicone may be applied to the monolithic, generally toroid shaped insert 105, 200 to lubricate the insert. The lubricant may permeate through the closed cell, crosslinked foam and lessen the amount of friction exerted on the insert. Additionally, the lubricant may enable the monolithic, generally toroid shaped insert 105, 200 to be positioned within a tire 101 that is sufficient in size to substantially fill the inside of the tire.

### Example Procedures

The following describes procedures that may be implemented to insert the monolithic, generally toroid shaped insert 105, 200 into the tire 101. While the methods described herein are directed to the use of the monolithic, generally toroid shaped insert 105, 200, it should be understood that the described methods may be used with other foam inserts. In portions of the following discussion, reference will be made to the apparatus 100 of FIG. 1, and the monolithic, generally toroid shaped insert 200 described in FIG. 2. In this example, the sidewalls 203(1) and 203(2) of described the monolithic, generally toroid shaped insert 105, 200 may be positioned against the sidewalls of a tire (e.g., sidewalls 102(1) and 102(2) of tire 101).

Additionally, the inner surface 204 of the monolithic, generally toroid shaped insert 105, 200 may extend radially inward beyond the radially most inward portion of the sidewalls (e.g., 102(1) and 102(2)) of the tire into the opening 107 of the tire, such that the radius of the most inward portion of the monolithic, generally toroid shaped insert 105, 200 is less than the radius of the most inward portion of the tire (e.g., tire 101). In one or more implementations, the inner surface 204 of the monolithic, generally toroid shaped insert 105, 200 must be positioned against a rim on which the tire is configured to operate. As a result, the monolithic, generally toroid shaped insert 105, 200 may fill a space between the rim on which the tire is configured to operate and at least a portion of the inner surface 103 of the tire that is adjacent to the tread 106 of the tire. When the monolithic, generally toroid shaped insert 105, 200 is positioned within a tire 101, the outer surface 201 of the monolithic, generally toroid shaped insert 105, 200 may be positioned at least partially against the inner surface 103 of the tire 101.

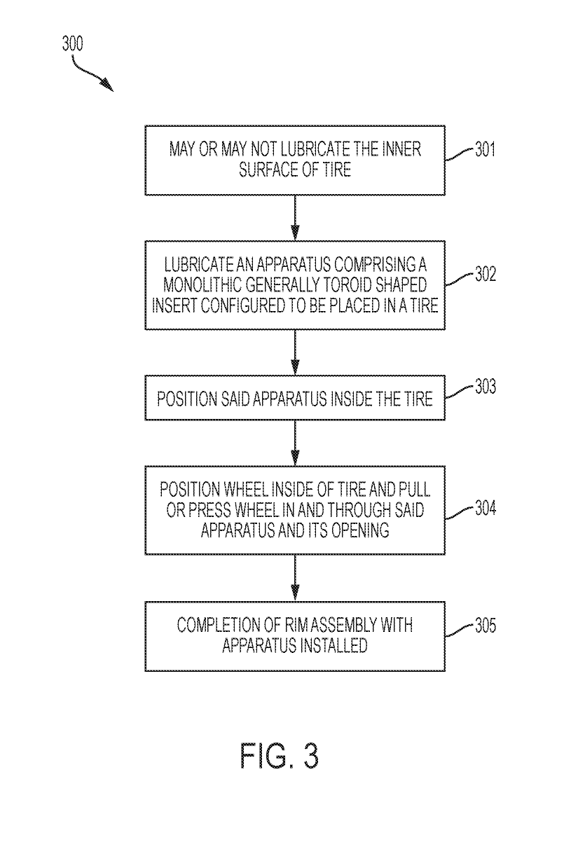

FIG. 3 depicts a method 300 for inserting the monolithic, generally toroid shaped insert 105, 200 into a tire (e.g., tire 101) to allow the tire to operate without air pressure (i.e., in a run-flat mode). In one or more embodiments, the monolithic, generally toroid shaped insert 105, 200 may be made of a material having a rigidity that enables the monolithic, generally toroid shaped insert 105, 200 to substantially fill the tire. The rigidity may be sufficient to maintain operability of the tire without positive air pressure.

At step 301, at the time of installation the tire 101 may or may not be lubricated. At step 302, the monolithic, generally toroid shaped insert 105, 200 is lubricated with a suitable lubricant. In one or more implementations, the monolithic, generally toroid shaped insert 105, 200 may be lubricated with Dimethylpolysiloxane Silicone to ease the insertion of the insert 105, 200 into the tire 101 and to also lessen friction exerted on the insert 105, 200 by the sidewalls 102(1) and 102(2) of the tire 101. However, this is an example method, and the monolithic, generally toroid shaped insert 105, 200 is not required to be lubricated.

At step 303, the user positions the insert 105, 200 within the cavity 104 defined inside the tire 101, which is previously discussed, by pushing the insert into the tire by hand, by a hydraulic machine, and/or by compressing the insert using any suitable means (e.g., hydraulics, press, etc.) to position the monolithic, generally toroid shaped insert 105, 200 within the tire 101.

At step 304, the user inserts a rim inside the opening 107 of the tire 101, which is defined as a space that is inward from the radially most inward portion of the sidewalls (e.g., 102(1) and 102(2)) of the tire, and also inside the inner surface 204 formed in the insert 105, 200. For example, in various embodiments, the user may use a wheel clamp tire changer (e.g., hydraulic machine) that either pushes, pulls or presses the rim though the tire opening 107 and within the inner surface 204 of the monolithic, generally toroid shaped insert 105, 200. Examples of such tire changer machines include the 5000 Series Tire Changer by Hennessy Industries, Inc., a Motorcycle Tire Changer Machine Model RC-100 by Hennessy Industries, Inc. or the Model CHD-9043 Heavy Duty Tire Changer by Hennessy Industries, Inc. It should be understood that any suitable tire changing machine may be used to insert the rim. Additionally, in other embodiments, any other suitable machine such as a hydraulic press table, winch table, etc. may be position the rim though the tire opening 107 and within the inner surface 204 of the monolithic, generally toroid shaped insert 105, 200. Finally, at step 305, the completion of the wheel assembly is performed such as setting the bead on the rim and inflating the tire with the proper level of air pressure.

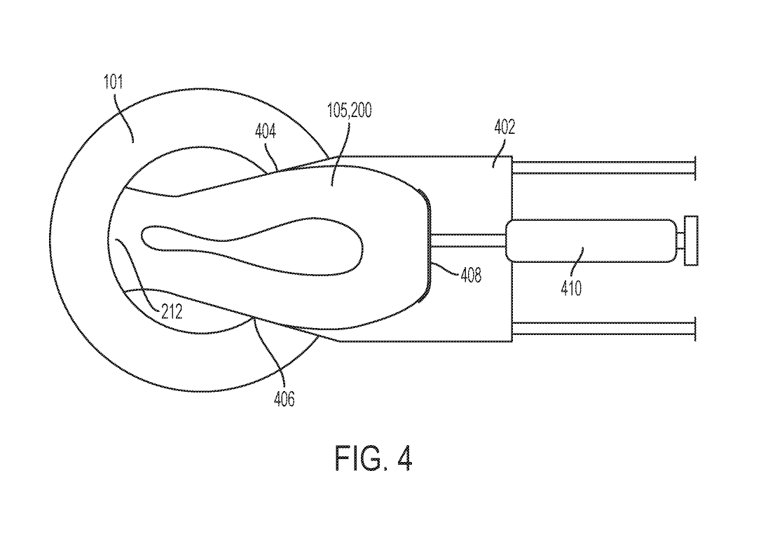

FIG. 4 illustrates a machine and method of installing the monolithic, generally toroid shaped insert 105, 200 into a tire 101. The insert is mounted into a frustoconical flat table 402 having side walls 404 and 406. A ram plate 408 that is coupled to a hydraulic or pneumatic cylinder 410 is used to push the insert 105, 200 between the conically positioned walls 404 and 406. Thus, as the insert 105, 200 is squeezed and compressed between the walls 404 and 406, the flat table 402 is moved in the opposite direction of the ram plate 408 so that the user can direct a portion 212 of the insert 105, 200 that moves out from between the walls 404 and 406 into the tire cavity 104. That is, the user can direct the portion 212 into the tire cavity 104 as the portion 212 extends from between the walls 404 and 406.

It should be understood that the monolithic, generally toroid shaped insert 105, 200 may be compressed in any suitable manner, whether by hand or by machine in order to position the monolithic, generally toroid shaped insert 105, 200 into the tire 101. Thus, other machines may be used and fall within the scope of the systems and methods disclosed herein.

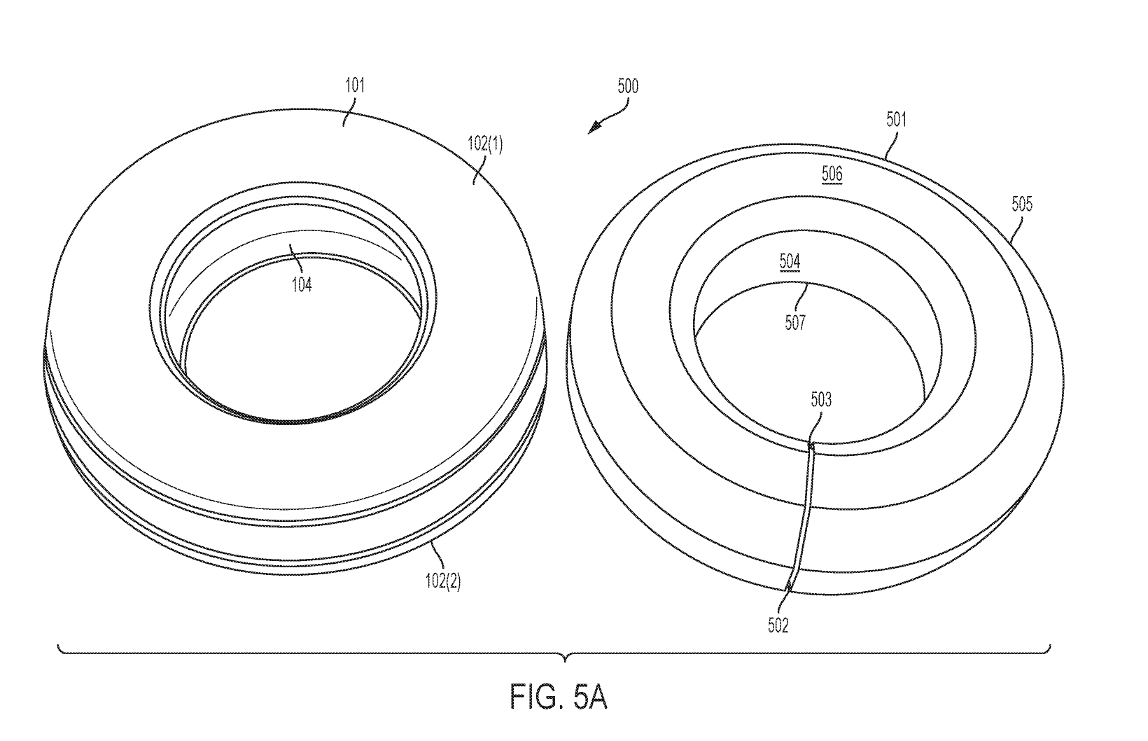

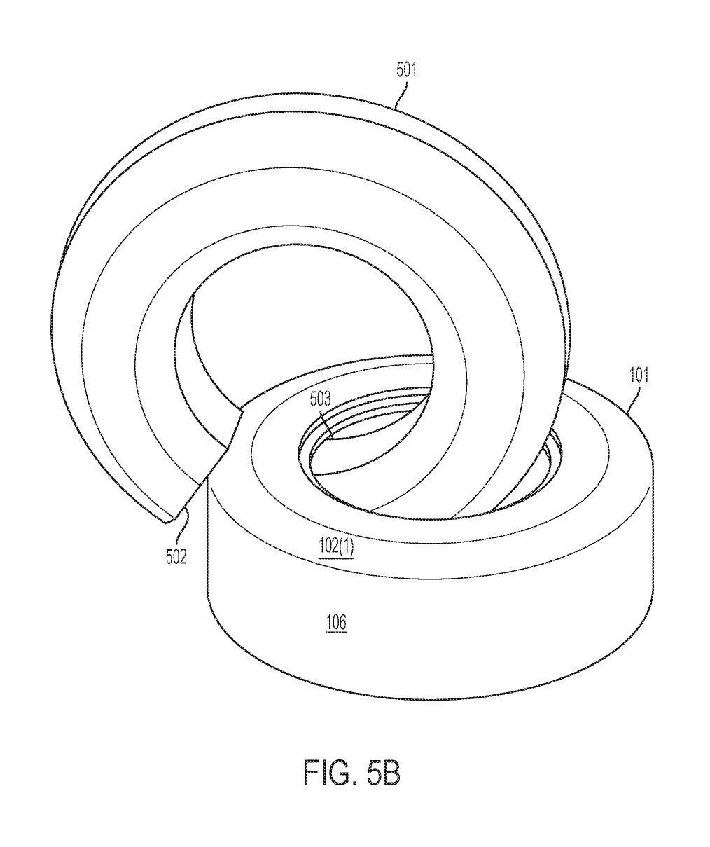

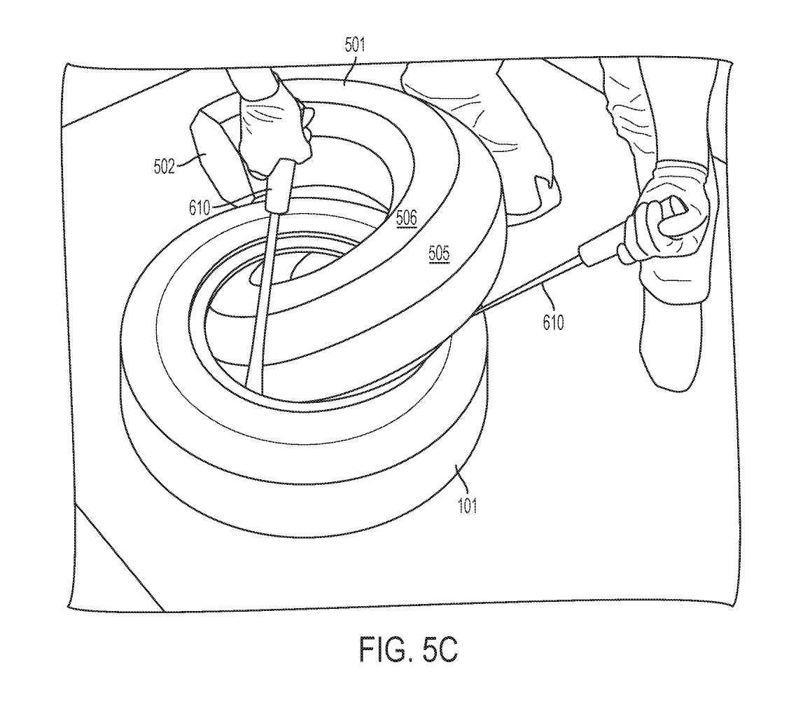

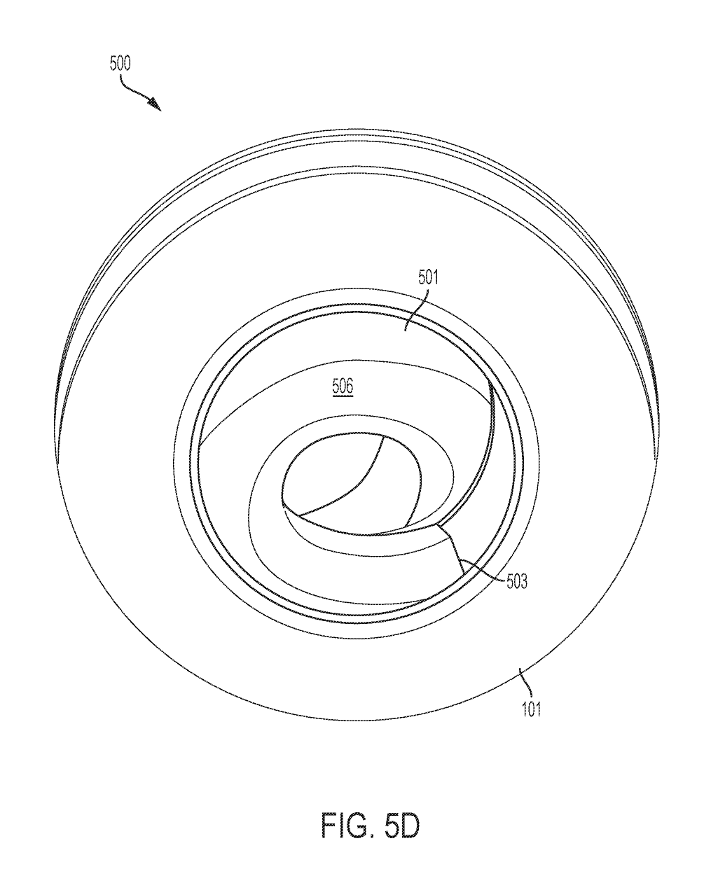

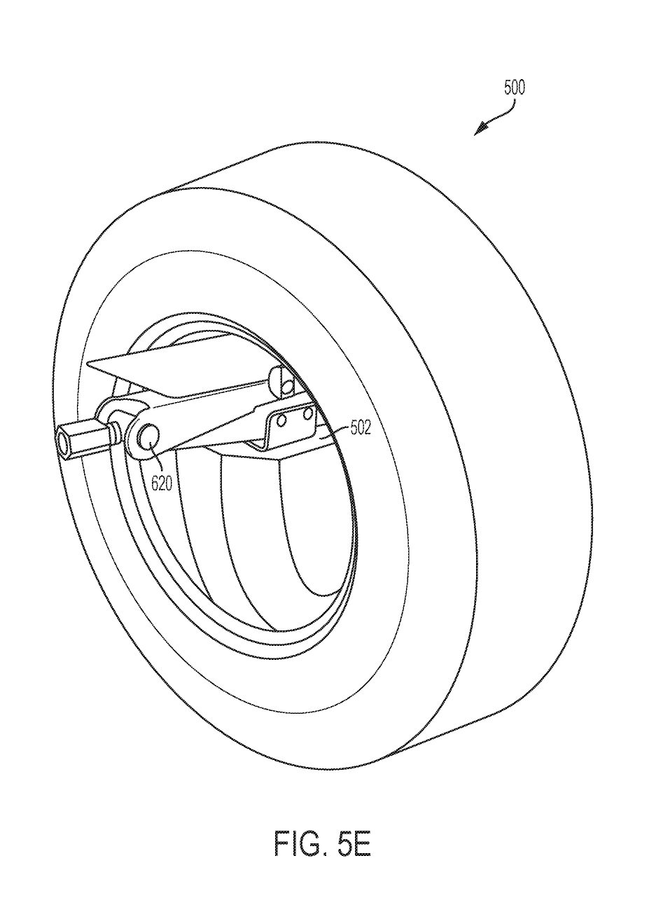

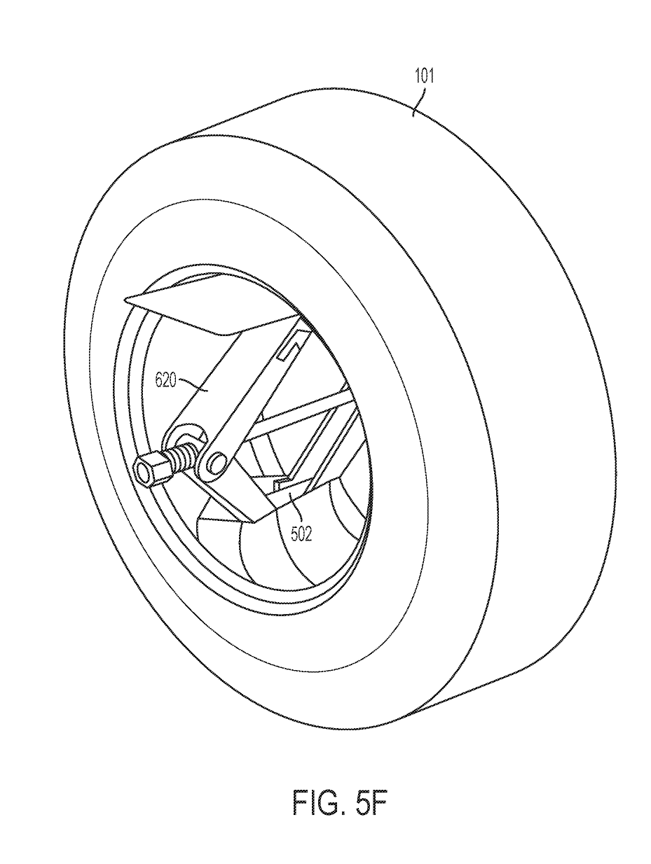

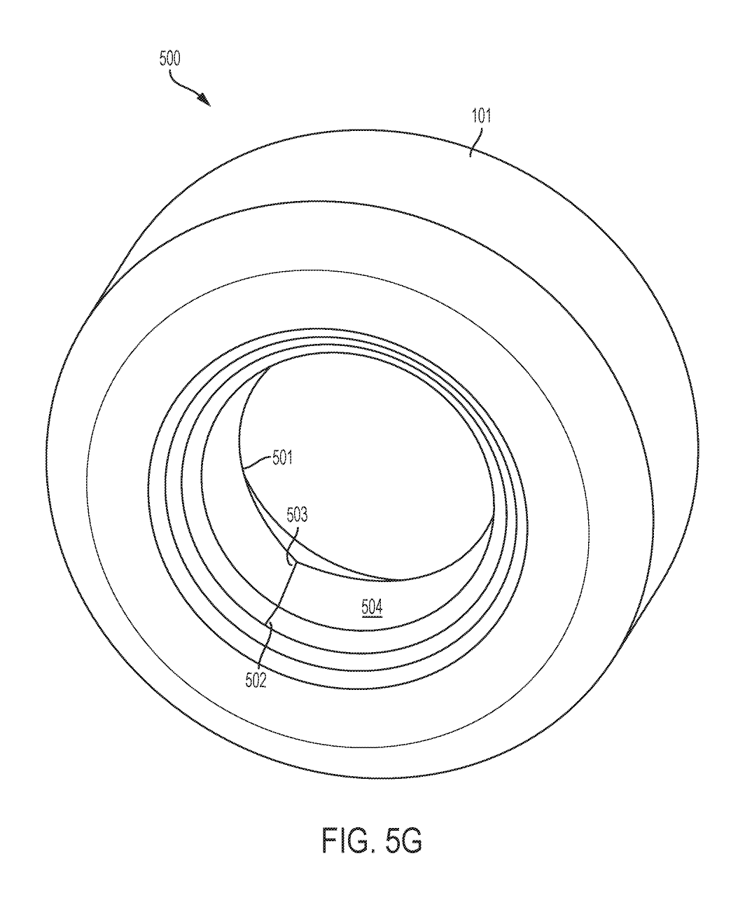

FIGS. 5A-5G show a sequence of steps in another example implementation 500 to cause the monolithic, generally toroid shaped insert to be positioned within a tire. FIG. 5A shows a tire 101 and a monolithic, generally toroid shaped insert 501 that may be one of the monolithic, generally toroid shaped inserts 105, 200 described above. The monolithic, generally toroid shaped insert 501 includes a slit that extends the full length of the cross-section of the insert 501 (e.g., between sidewall 203(1) and 203(2)). The monolithic, generally toroid shaped insert 501 includes a first end 502 and a second end 503 that are each an interior surface defined on each side of the slit. Additionally, the monolithic, generally toroid shaped insert 501 includes an inner surface 504 (which may be inner surface 204) outer surface 505 (which may be outer surface 201), and sidewalls 506 and 507 (which may be sidewalls 203(1) and 203(2)).

The first end 502 or the second end 503, shown as the second end 503 in FIG. 5B, may be inserted in to the cavity 104 of the tire 101. The second end 503 may be inserted in to the cavity 104 such that the first end 502 contacts a portion of the sidewall 102(1) or the tread 106 of the tire 101. Additionally, when the first end 502 or the second end 503 is inserted into the cavity 104, the monolithic, generally toroid shaped insert 501 may be substantially perpendicular to the tire 101. Prior to inserting any portion of the monolithic, generally toroid shaped insert 501 in to the tire 101, one or more portions of the monolithic, generally toroid shaped insert 501 may be lubricated.

In the example implementation 500, an installer may push the monolithic, generally toroid shaped insert 501 in to a position where at least a portion of the outer surface 505 is in the cavity 104 of the tire. As shown in FIG. 5C, the installer may use hand tools 610 (e.g., shown as tire spoons in FIG. 5C) to continue the process of positioning additional portions of the monolithic, generally toroid shaped insert 501 within the cavity 104 of the tire. For example, as shown in FIG. 5C, the installer may apply radially inward force (e.g., with one or more tire spoons) to a portion of the monolithic, generally toroid shaped insert 501 move additional portions of the insert 501 into the opening 107 of the tire 101, and then release the applied radially inward force such that the outer surface 505 of that portion fits within the cavity 104. The installer may continue this process with one or more different portions of the monolithic, generally toroid shaped insert 501 until the insert is positioned in the tire cavity 104, as shown in FIG. 5D.

In the example implementation 500, once the installer has continued the process of applying radially inward force to multiple portions of the monolithic, generally toroid shaped insert 501 to position the outer surface 505 of the portions within the cavity 104 of the tire 101 as shown in FIG. 5D, the installer may reach an impasse to completing the installation of the monolithic, generally toroid shaped insert 501. In such a case, as shown in FIG. 5E, the installer may incorporate a different tool, shown as a scissor jack 620, to complete the installation. A scissor jack 620 is shown in FIGS. 5E and 5F; however, any other type of jack or mechanism to radially exert force on the monolithic, generally toroid shaped insert 501 may be used. As shown in FIG. 5E, the scissor jack 620 may be used in an upside-down manner (i.e., where the larger foot print of the jack is contacting the monolithic, generally toroid shaped insert 501) to contact the first end 502. The scissor jack 620 may then positioned against the beads of sidewalls 102(1) and 102(2) of the tire 101, and the portion of the scissor jack 620 contacting the first end 502 may be used to exert radial force on the first end 502. As a result, the extension of the scissor jack 620 causes a greater portion of the outer surface 505 to be positioned within the cavity 104 of the tire 101, as shown in FIG. 5F. Finally, as shown in FIG. 5G, the monolithic, generally toroid shaped insert 501 is positioned within the tire 101 so that the ends 502 and 503 of the insert 500 are positioned adjacent one another.

### CONCLUSION

Although the invention has been described in language specific to structural features and/or methodological acts, it is to be understood that the invention defined in the appended claims is not necessarily limited to the specific features or acts described herein. Rather, the specific features and acts are disclosed as exemplary forms of implementing the claimed invention.

What is claimed:

1. A run-flat tire comprising:
a. a monolithic, generally toroid shaped insert comprising:
i. a first sidewall,
ii. a second sidewall,
iii. an outer surface that couples the first sidewall to the second sidewall; and
iv. an inner surface that couples the first side wall to the second sidewall; and
b. a tire comprising:
i. a first tire sidewall having a first edge defining a first bead and a second edge;
ii. a second tire sidewall having a first edge defining a second bead and a second edge; and
iii. a tread coupling the first tire sidewall second edge to the second tire sidewall second edge; and
c. a rim, wherein
the monolithic, generally toroid shaped insert has an outer diameter that is substantially equal to the outer diameter of the tire when the tire is not inflated with air, and
the monolithic, generally toroid shaped insert has an inner diameter that is slightly smaller than the outer diameter of the rim so that when the rim is inserted into an opening defined by the inner surface, the monolithic, generally toroid shaped insert has a friction fit with the rim.

2. The run-flat tire insert of claim 1, wherein the monolithic, generally toroid shaped insert is formed from a closed cell, cross linked polyethylene foam material.

3. The run-flat tire insert of claim 1, wherein:
a. the tire further comprises a tire inner surface positioned radially inward from the tread and extending between the first tire sidewall and the second tire sidewall, and
b. the monolithic, generally toroid shaped insert is configured to be positioned within a cavity of the tire such that at least a portion of the monolithic, generally toroid shaped insert contacts at least a portion of the tire inner surface.

4. A run-flat tire insert that is configured to be received inside a cavity of a tire, comprising a monolithic, generally toroid shaped insert comprising:
a. a first sidewall,
b. a second sidewall,
c. an outer surface that couples the first sidewall to the second sidewall; and
d. an inner surface that couples the first side wall to the second sidewall; wherein
the monolithic, generally toroid shaped insert has an outer diameter that is substantially equal to an outer diameter of a tire in which the monolithic, generally toroid shaped insert will be installed into when the tire is not inflated with air.

5. The run-flat tire insert of claim 4, wherein the monolithic, generally toroid shaped insert has an inner diameter that is slightly smaller in diameter than the inner diameter of the tire opening so that when insert is installed in the tire, the insert extends radially inward of the cavity of the tire and into the opening defined by the tire.

6. The run-flat tire insert of claim 4, wherein the monolithic, generally toroid shaped insert is formed from a closed cell, cross linked polyethylene foam material.

7. The run-flat tire insert of claim 4, wherein the monolithic, generally toroid shaped insert has a density of about 2 lb/ft³-6 lb/ft³.

8. The run-flat tire insert of claim 4, wherein the monolithic, generally toroid shaped insert has a density of about 4 lb/ft³-16 lb/ft³.

9. The run-flat tire insert of claim 8, wherein the monolithic, generally toroid shaped insert has a density of about 8 lb/ft³-14 lb/ft³.

10. The run-flat tire insert of claim 4, further comprising a first inner edge that couples the first sidewall to the inner surface and a second inner edge that couples the second sidewall to the inner surface.

11. The run-flat tire insert of claim 10, wherein the first inner edge and the second inner edge are rounded.

12. The run-flat tire insert of claim 4, further comprising a first outer edge that couples the first sidewall to the outer surface and a second outer edge that couples the second sidewall to the outer surface.

13. The run-flat tire insert of claim 10, wherein the first outer edge and the second outer edge are rounded.

14. A method of installing a run-flat tire insert into a tire comprising:
a. compressing a first portion of a monolithic, generally toroid shaped insert;
b. pushing the first portion into a cavity defined by a tire inner surface, a first tire sidewall, and a second tire sidewall;
c. continually compressing a second portion of the monolithic, generally toroid shaped insert;
d. pushing the second portion into the cavity of the tire;
e. compressing a last portion of the monolithic, generally toroid shaped insert; and
f. pushing the last portion into the cavity of the tire;
wherein the monolithic, generally toroid shaped insert expands when placed into the cavity of the tire so that at least a portion of an outer surface of the monolithic, generally toroid shaped insert is positioned against at least a portion of the tire inner surface, and at least a portion of a sidewall of the monolithic, generally toroid shaped insert is positioned against a portion of at least one of the first tire sidewall and the second tire sidewall when the tire is not inflated.

15. The method of claim 14, wherein the monolithic, generally toroid shaped insert comprises:
a. a first sidewall,
b. a second sidewall,
c. an outer surface that couples the first sidewall to the second sidewall; and
d. an inner surface that couples the first side wall to the second sidewall,
wherein the monolithic, generally toroid shaped insert has an outer diameter that is substantially equal to an outer diameter of the tire.

16. The method of claim 15, wherein the first portion of the monolithic, generally toroid shaped insert is the first end, and the last portion of the monolithic, generally toroid shaped insert is the second end.

17. The method of claim 15, wherein continually compressing the second portion of the monolithic, generally toroid shaped insert further comprises:
a. applying radially inward force such that the outer surface of the monolithic, generally toroid shaped insert is positioned within an opening of the tire, and
b. releasing the applied radially inward force such that the outer surface of the monolithic, generally toroid shaped insert fits within the cavity of the tire.

18. The method of claim 17, wherein the radially inward force is applied with one or more tire spoons.

19. The method of claim 14, wherein the monolithic, generally toroid shaped insert includes a first end and a second end that are defined by a slit that extends the full length of the cross-section of the monolithic, generally toroid shaped insert.

20. The method of claim 14, further comprising the step of lubricating the monolithic, generally toroid shaped insert prior to compressing the monolithic, generally toroidal foam insert.
